(19) United States
(12) Patent Application Publication
(10) Pub. No.: US 2005/0137783 A1
(43) Pub. Date: Jun. 23, 2005

(54) Traffic control and vehicle spacer system for the prevention of highway gridlock

(76) Inventor: David Bogart Dort, Washington, DC (US)

Correspondence Address: TIGHE PATTON ARMSTRONG TEASDALE PLLC;VRBIA, INC DEPT, BOX 27519, WASHINGTON SQUARE STATION, WASHINGTON, DC, 20038-7519, US

(21) Appl. No.: 10/772,776

(22) Filed: Feb. 5, 2004

Related U.S. Application Data
(60) Provisional application No. 60/529,973, filed on Dec. 17, 2003.

(51) Int. Cl. G06F 19/00

(52) U.S. Cl. 701/119; 701/117

(57) ABSTRACT

The present invention minimizes the impact of driver habits and/or external events that lead to traffic congestion problems, by regulating the vehicle speed and spacing through controls that are either physical or electronic and received by the vehicle.

### REFERENCE TO PRIORITY DOCUMENTS

This patent application claims priority to U.S. Provisional application 60/529,973 entitled TRAFFIC CONTROL AND VEHICLE SPACER SYSTEM FOR THE PREVENTION OF HIGHWAY GRIDLOCK by David Bogart Dort, filed in the United States Patent and Trademark Office on Dec. 17, 2003 and which is incorporated by reference for all purposes.

### BACKGROUND

It is well known in traffic flow applied mathematics that the closer vehicles are spaced together for a large number of vehicles, the slower the flow, this is shown by the general traffic flow principle of the equation: where r(n,m) is the distance between two vehicles, n and m, and dn/dt and dm/dt represent the velocity of the two vehicles:.
as r(n,m)→0, dn/dt→0 and dm/dt→0 as well.

The main problem in getting a congestive traffic event flowing again is actually the behavior of the drivers themselves. FIGS. 30 and 31 shows the behavioral characteristics of drivers that cause the continued gridlock problems. The main problems is that drivers fail to space themselves from the vehicle in front of them (or in a merge situation a two-dimensional spacing), thus keeping r(n,m) close to 0 at all times. Even if a driver is attempting to space themselves from the leading vehicle, an erratic “dissipation speed” may bunch the two cars again keeping traffic from flowing. FIG. 17A depicts the initial dissipation of the traffic congestion event, shown by a star, in which r(n,m) initially may increase, but as shown in FIG. 17B r(n,m) is decreased through driver behavior (acceleration (a(n)), not letting a vehicle merge properly, etc.) or other circumstances to decrease distance and leading back to congestion. FIG. 17C also depicts another type of congestion based on driver habits in a highway merge zone which causes unnecessary slowing and congestion problems.

A way to keep spacing during a congestion event would facilitate traffic flow and reduce the problems caused by driver impatience.

### SUMMARY OF THE INVENTION

The present invention is design to complement the existing transportation infrastructure in order to alleviate ever-worsening traffic congestion in problematic areas, by minimizing the impact of driver habits and/or external events that lead to congestion problems. Events alleviated by the present invention may be naturally occurring roadway infrastructures such as merges, lane shifts, exits, expected criteria, like rush hours stand-stills, HOV activation. Further, vehicles allowing their speed and spacing to be controlled should have access to high flow lanes. It is appreciated that this invention will best and most safely be implemented at low speeds when congestion is most problematic. In particular embodiments, the invention will regulate multiple vehicle velocity and/or acceleration via a transmission device connected to a computation network that detects events, and a receiver system in the vehicles that translate transmitted signals for control of vehicle acceleration.

### BRIEF DESCRIPTION OF THE DRAWINGS

FIG. 1 is the traffic flow control system before activation.

FIG. 2 is the traffic flow control system after activation.

FIG. 3 shows the representation slot zones and sample corresponding velocities for spacing.

FIG. 4 is a merge control system embodiment of the invention.

FIG. 5 is the traffic control invention that is implemented to stationary or moving transmitters in the speed control zone.

FIG. 6 is a subscription service for flow control with stationary or moving transmitter controls.

FIG. 7 is a method for implementing the traffic flow control subscription service.

FIG. 8 is a first embodiment of the RFID traffic flow control system with optional ID recognition;

FIG. 9 is a transmission and receiver device represented by functional blocks in a first embodiment;

FIG. 10 is an alternate embodiment of the present invention wherein receivers and transmitters are located on vehicles in the congestion reduction zone;

FIG. 11 is an alternate embodiment of the invention in a traffic control for a highway merge;

FIG. 12 is a sample diagram of unidirectional non-negative acceleration control in the present invention as implemented by a governor system;

FIG. 13 is a second alternate embodiment for multiple lane traffic flow control in a highway merge;

FIG. 14 illustrates the networked velocity control computation system;

FIG. 15A and B is a sample flow control computation table for single and multiple-lane flow control, respectively;

FIGS. 16A and B are a side view at first time and second time, respectively, of the representation control mechanisms of the traffic flow control invention before activation as could be implemented in an additional alternate embodiment of the invention;

FIGS. 17A, B, and C show traffic flow congestion events;

FIG. 18 shows the components of an inter-vehicle traffic control system.

### DETAILED DESCRIPTION

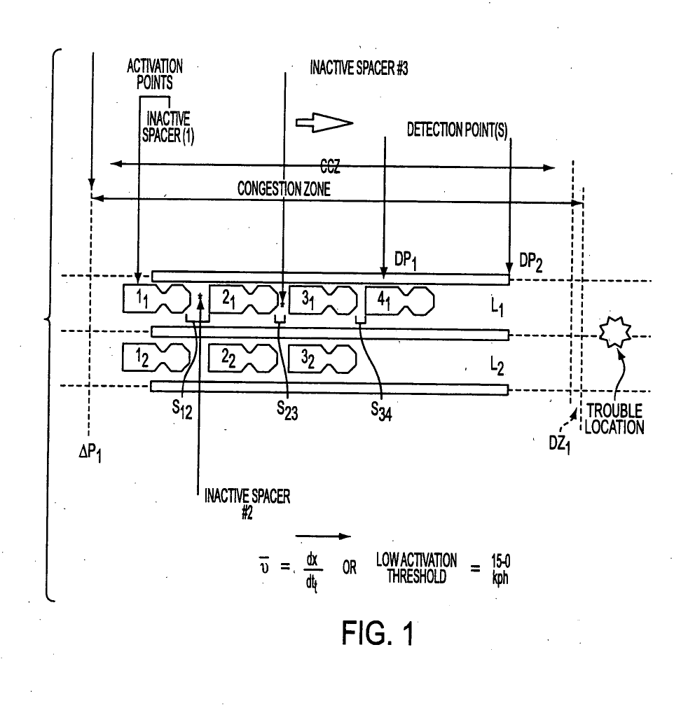

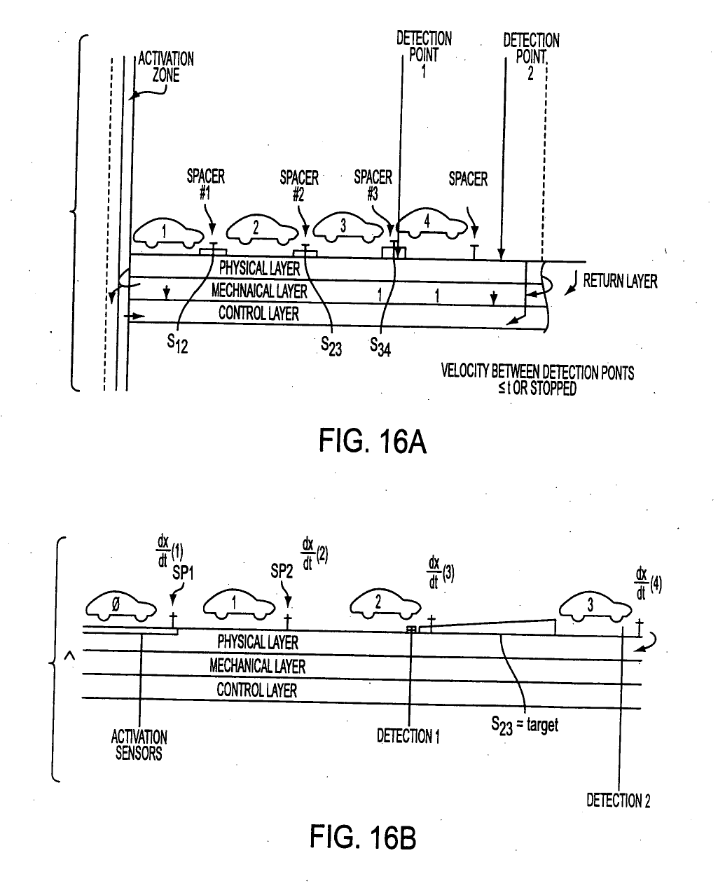

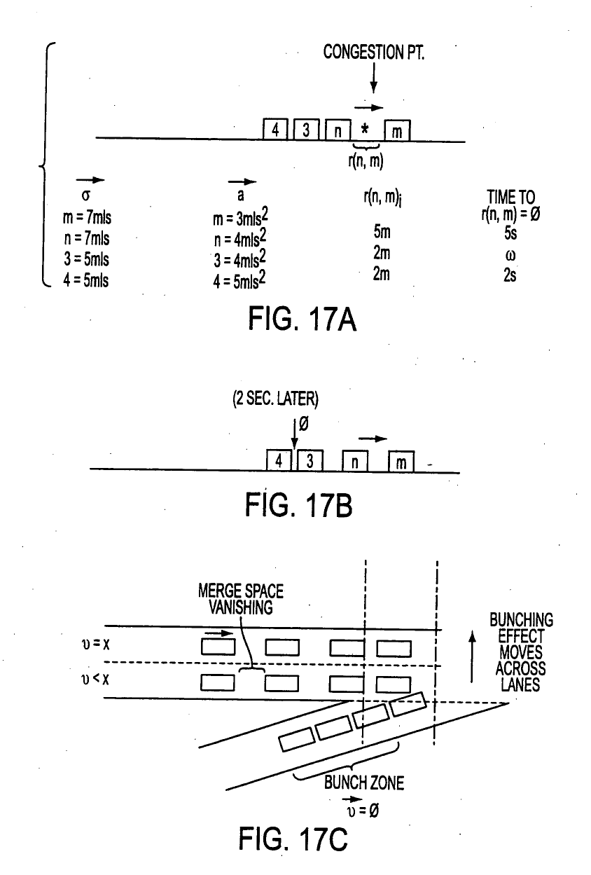

A traffic flow event, such as stopped vehicles is detected to motion detectors at detection points in the speed control area or congestion control zone is shown in FIGS. 17A-C. Referring now to FIG. 1, a functional diagram of the invention is shown. The stopped or slowed vehicle(s) in lane 1, L1 shown as V1(1), V2(1), V3(1), V4(1) activates the spacing system at the activation zone, AZ, or activation points, AP(x), AP(1) that activate and allows spacers S(reamum, frontnum), shown as S(1-2), S(2-3), S(3-4)to prevent vehicles from bunching up or “stop and go.” The spacers can be physical devices such as Kevlar flags attached to a moving conveyor (with appropriate springs or other mechanical protection in the mechanical movement area or layer (FIG. 16A) or can be electronic such as lights or diodes, but in a preferred embodiment are transmitter-receiver systems which control the speed of the vehicle, through controlling the acceleration of the vehicle after an event is detected at detection points, DP(1), DP(2) or detection zones DZ(1).

In the description of the invention; the terms velocity, speed and acceleration are used interchangeably, but the preferred concept is acceleration, preferably non-negative acceleration. Skilled artisans can appreciate that acceleration calculations include consideration of velocity, when acceleration is zero (non-negative is used throughout the disclosure) and speed is simply the velocity (zero acceleration) without the consideration of vector. Thus, while the control of vehicle speed is an important feature of the invention in reducing traffic congestion after a traffic event, the consideration of those calculations of delta in velocity over time and direction (particularly in the merge and other multiple lane embodiments of the invention) are covered fully by the use of the terms acceleration and non-negative acceleration.

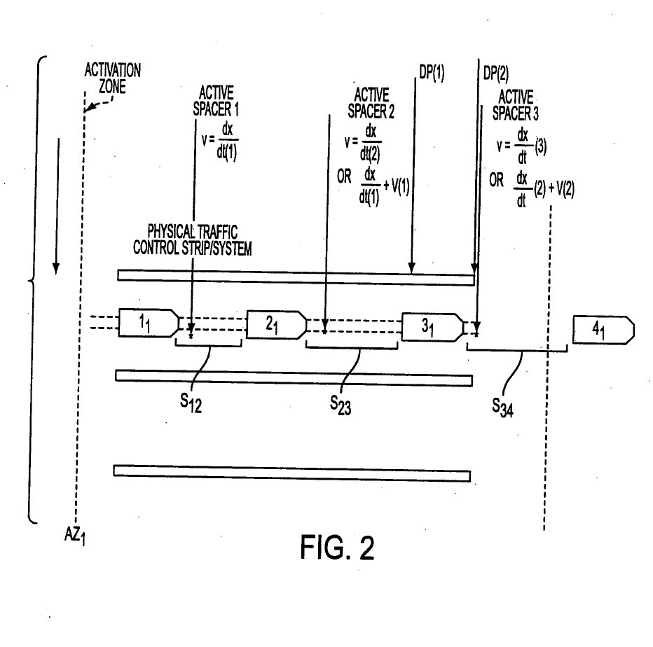

FIG. 2 shows the conceptual implementation of the invention with the spacers implementing the flow control (or in an active state). Spacer controls S(1-2), S(2-3) and S(34), are activated when an activation event is detected at detection zone or detection point(s), DP1, DP2, such as the velocity of any vehicle in the congestion zone (not shown) reaches a low threshold, which is zero in a preferred embodiment. Spacer S(34) allows the distance to increase between vehicles V4 and V3, in lane L1, by allowing V4 to accelerate faster than V3. Similarly V3 is allowed to accelerate faster than V2 through spacer S(2-3), increasing the distance between V2 and V3. The spacers are either simultaneously or serially deactivate, when a release event is detected in the detection zone or detection points, DP1 or DP2. For example if the velocity of a vehicle at DP(1) is 10 m/s then traffic flow is no longer necessary in at least a portion of the congestion zone. Other release event criteria may be appropriate such as the distance between V4 and V3, or any two vehicles in the sequence is great enough where flow control is no longer necessary. One of the advantages of the present invention is that it need not be active when traffic is flowing acceptably.

The sensors at the detection points will determine that the traffic congestion event has ended and deactivate the spacers allowing traffic to proceed normally. It is contemplated that these sensors are generally well-known as stand-alone devices, and can be pressure strips in the roadway, optical sensors, RADAR velocity detectors, timing devices, or any combination thereof. It can be appreciated that the particular traffic sensing device is not vital to the invention other than the information detected will have to be processed by the control system and thus, interface devices should be careful considered during implementation, in addition to environmental conditions, durability and cost. For example pressure strips in the roadway may have more maintenance free durability than other devices.

As will be discussed subsequently, the calculations necessary to produce the desired spacing, velocity and acceleration control range from simple to complex calculations for the application of differential equations to traffic flow problems. A good reference regarding the calculation/computation aspect of the invention is Traffic Flow Fundamentals, by May (Prentice-Hall, 1989), Mathematical Theories of Traffic Flow, by F. A. Haight, (Academic, 1963), as far as teaching the necessary computation solutions related to traffic control implementation, these references are incorporated by reference. Particularly useful references published by the Transportation Research Board are Highway Capacity Traffic Flow and Traffic Control Devices, (June, 1977) and Traffic Flow Theory and Highway Capacity (June 1989), which are both incorporated by reference herein for all purposes. Another useful reference is Multiclass Continuum Modelling of Multilane Traffic Flow by Serge Hoogendoom, (Coronet, 1999). The computational aspects of the invention are not the novel and non-obvious aspects, but are important aspects of implementing the invention in simple or complex traffic control systems.

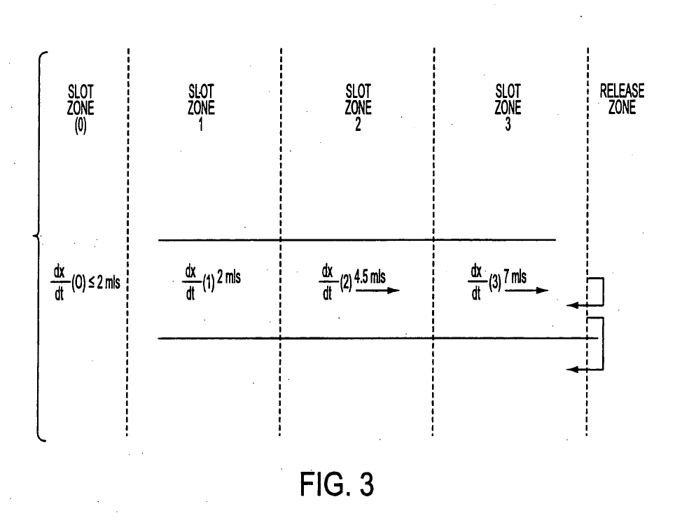

Referring now to FIG. 3, a portion of the congestion zone (not shown) includes a control zone or Slot Zone, shown as SZ0, SZ1, SZ2, SZ3 at one end of the congestion zone is a release zone (RZ), which may be any of the slot zones if it is appropriate, but is shown for illustrative purposes such that velocity, spacing and acceleration control is not present in this zone. As illustrated by FIG. 3 the average velocity in the respective slot zones allows for the spacing of vehicles in the front of the zone. Thus, vehicles in SZ3 are allowed to travel at 7 m/s, in SZ2 4.5 m/s, SZ1 2 m/s. In SZ0 the average vehicle velocity may or may not need to be controlled depending on the conditions in the front slot zones.

FIG. 3 shows representational slot zones with sample velocities that allow the vehicles to space out increasing traffic-flow speed. The structures are a single embodiment of the invention, but not the preferred embodiment as it is contemplated that building any type of infrastructure would be prohibitive difficult with existing crowded highways. Rather, the effect of the physical structures may be contemplated in other embodiments that implement components that require cooperation between systems and will be discussed below.

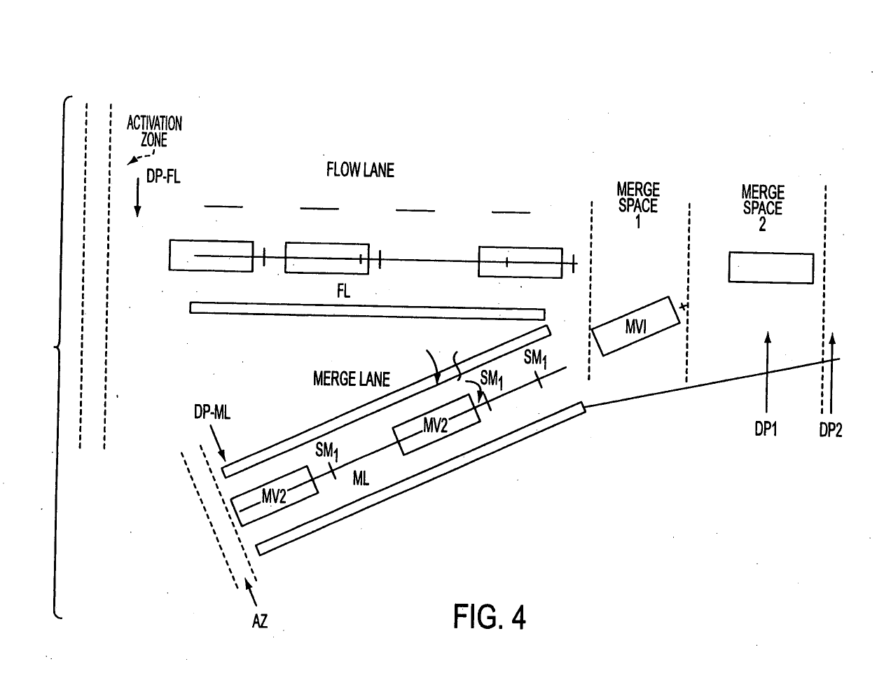

As can be appreciated, the spacing control system may also be implemented in two dimensions. Not so much as an X and Y directions, but with regards to merges, exits, multiple lane controls, etc. The system can be used in the forward direction for single lane control flow, but also can be used for merging control such as on-ramp allowing cars to automatically enter a created space, which is shown in FIG. 4. Thus, velocity control of vehicle in both the merging lane ML (MV1, MV2, MV3) and the Flow lane FL (FV1, FV21 . . . ) may be necessary. Although velocity control in only the merging lane ML may be needed depending on the events detected in detection points DP1 and DP2. Although in the merge lane context detection points, DP-FL and at the rear of the congestion zone (not shown) and the merge lane DP-ML may be more desirable.

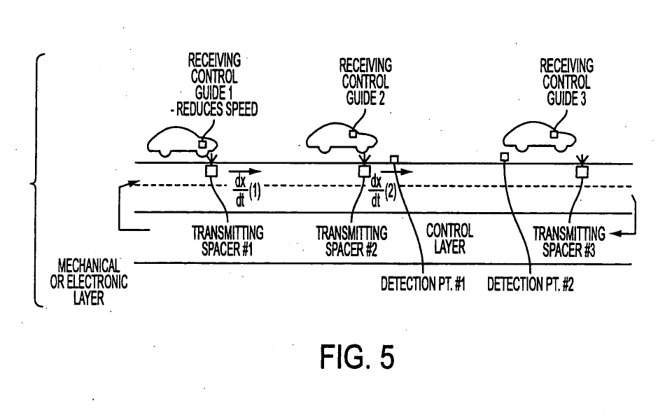

Referring now to FIG. 5, a preferred embodiment includes a transmission device connected to a control system and a governor-receiver in the vehicle that responds to each transmitter through a RFID system, such that the vehicle cannot accelerate beyond the appropriate slot zone speed after activation. Thus the vehicle in front is allowed to travel at 7 m/s while the vehicle in position 1 is only allowed to travel at 1 m/s until reaching slot zone 2. The passive RFID systems are commonly implemented in such commercial applications as EZ-PASS in which a RFID device reads a transponder located in a moving vehicle to record a toll fee and to send a monthly bill. The transmission and reception system will be described more in detail below.

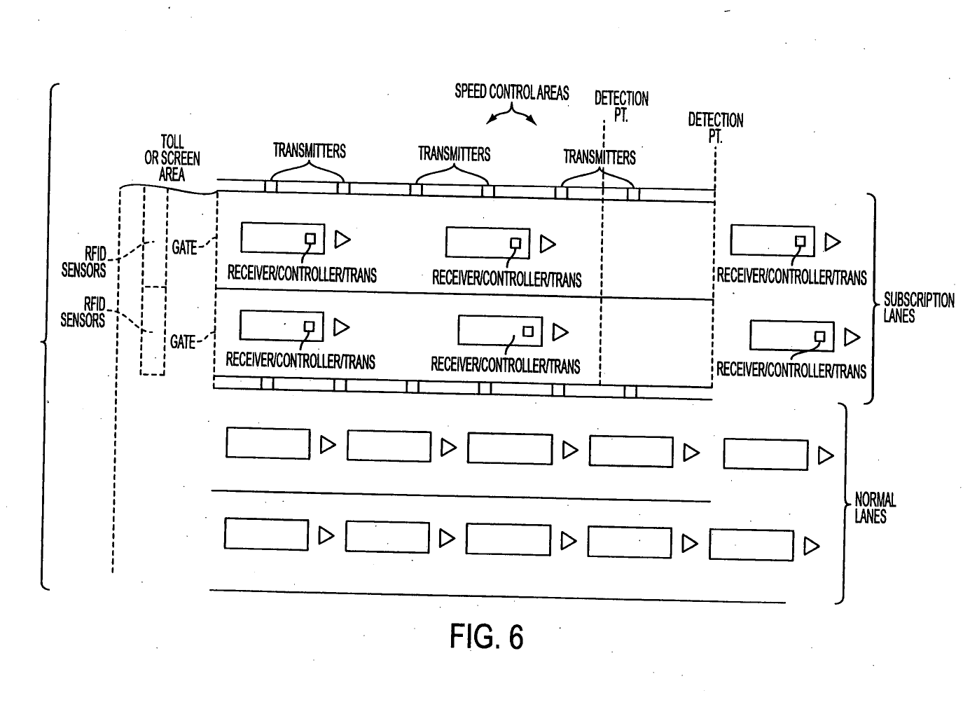

Referring now to FIG. 6, special lanes may only be entered through an RFID gate or tollway, in which cars have the automatic control (or not for a special tollway) allowing the top speed of the car to be governed in the case of a congestion event. Transmitters beneath or on the side of the roadway transmit the appropriate spacing speed for the slot zone preventing all congestion through proper traffic spacing.

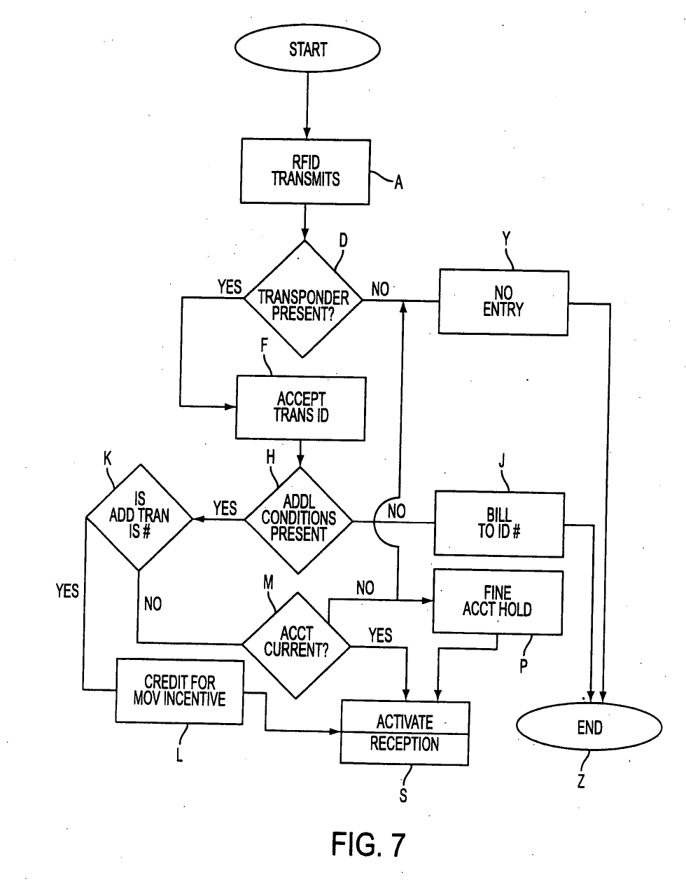

Referring now to FIG. 7, a method for implementing an access controlled traffic flow regulated system, like that shown in FIG. 6 is described. The access control (step F) may implement desired regional traffic infrastructure features such as high occupancy vehicle (HOV) lane compliance. For example, in one of the implementations of the present invention, each subscriber is given an RFID transponder in the form of a keycard (not attached to the receiver). During HOV only rush hour periods, there must be two keycards in the vehicle at the TOLL SCREEN POINT in FIG. 6 to access the congestion-reduced zones of the present invention. In order that traffic not get jammed at the toll entrance, if an account holder accesses the congestion reduction zone without an additional keycard present (or a low account balance or other scenario) they may be charged additionally or taxed. Of course, a vehicle may simply be prevented from entering the zone without the special adaptation receivers, or charged additional money for such. It is contemplated that if multiple levels of access are desired a series of two or more RFID systems may be desired. Thus, the incentives to travel in the reduced congestion lanes which may be blocked off from the regular travel lanes can be adapted to help solve the needs of the regional traffic authorities.

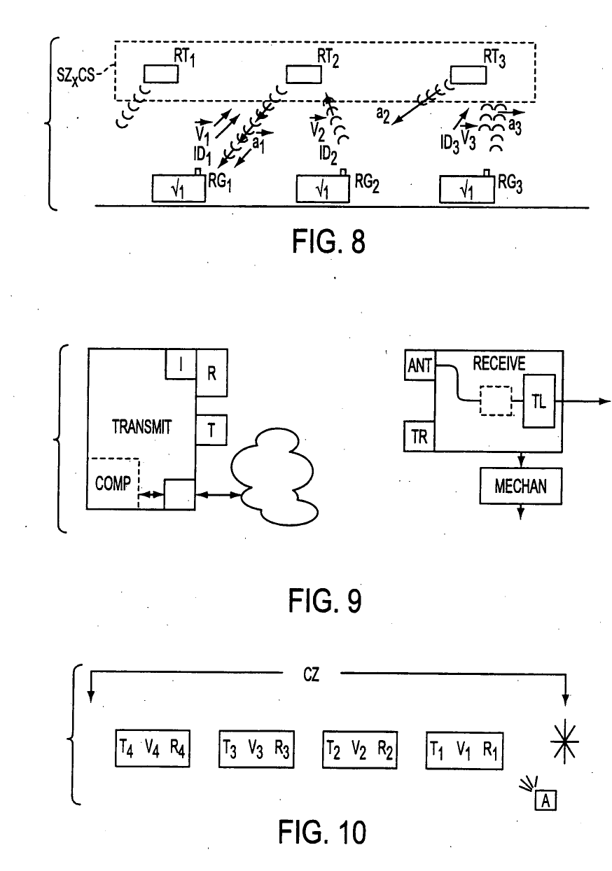

Referring now to FIG. 8, a single transmission reception zone SZx is shown. In the control system for the slot zone SZxCS there are three transmitters RT1, RT2, RT3, and three sample vehicles V3, V2, V1 (the order has been changed to show that numbering is arbitrary and for purposes of illustrations) with three respective velocities, σ1, σ2, and σ3 (“σ” is used for velocity instead of v).

FIG. 8 also shows an optional initial transmission states as it applies to vehicles V1, V2 and V3 with respective receiver controller/governors RG1, RG2, and R3, respectively is shown. An optional ID is detected by the transmitter(s) RT2 and RT3 in a fashion similar to the EZ-PASS RFID systems used in toll lanes on many highways and based on a transponder located in a vehicle and in particular in the RGx device or adjacent thereto. Similarly, an optional broadcast of the vehicles current velocity al takes place along similar lines, although the broadcast is not passive like an ID would be. In a second transmission state an acceleration or velocity limit(s) a1, a2, and a3 are broadcast to the RG devices in order that the vehicles will not accelerate too quickly and create unnecessary congestion.

Referring now to FIG. 9 a representative transmitter system T and receiver system R are shown. The transmitter system T may be an RFID broadcast device or other EMF transmission device using an appropriate frequency (approved by the FCC or on a free channel). The transmitter may also use optical signals. The transmitter system includes a transmitter Tr and a computational device COMP, which may be physically located in the transmitter system or virtually connected through transmission, LAN, or specialized network to,other transmitter system devices through an optional network interface NI. The transmitter system may include and optional receiver Rc and input interface I that allow information from the transponders to be received and processed. The network may allow each transmission system T to be activated upon the detection of a traffic congestion event or simply include computation information to be transmitted to the

Also shown in FIG. 9 is receiver system R, which include a device that allow acceleration or velocity control signals from the transmitter system T to be processed. An optional antenna or signal reception device takes EMF or other appropriate signals and processes them through an interface for translation in the translator TL, so that the signals may be used to control the acceleration of the vehicle. The processor PROC may be an ASIC designed specifically to quickly decode transmissions from the reception structures to a physical embodiment. As can be appreciated there are velocity/speed/acceleration control mechanisms used in vehicles for safety purposes, and in particular to slow SUVs when the SUV is detected by sensors to be in a rollover situation. As such, the driver of such vehicles is not in control of the velocity as it is being slowed to a safer speed.

Referring now to FIG. 12 an exclusively non-negative acceleration system is shown. The non-negative acceleration is part of a preferred embodiment of the invention and unlike the negative acceleration systems current used to prevent SUV rollover or other “slow down” mechanisms. Although it is contemplated that the present invention could use known deceleration devices in controlling the velocity of the vehicles, the reliability and safety of the velocity control system is though to be a more popular and economic implementation if vehicles are not “slowed” by external events. It is contemplated that limiting the positive acceleration when a vehicle has dropped below a low threshold speed would be a much more viable and safer option for drivers. Additionally, the redundancy required from a positive, or rather non-negative acceleration governor would be greatly reduced that for a device that could decelerate the vehicle as well.

FIG. 12 shows that a non-negative acceleration governor may be placed on standby but cannot be activated until the vehicle drops below a low threshold speed or event. In a preferred embodiment the low threshold is zero, but it may be other speeds according to the conditions that are appropriate for the congested roadway. FIG. 12 also shows that 3 different transmissions to the non-negative governor system result in three different velocities σ1 σ2 σ3 for the vehicle at three points in time.

Referring now to FIG. 10 another alternate embodiment of the invention is shown where the transmitter and receiver systems are located on vehicles in the congestion reduction zone. In this alternate embodiment, the inter-vehicle traffic control system, the transmitters T1 . . . T4 are activated when Activation module A transmits an EMF signal when an event at one or more detection points DP1 is detected. Such events may be the same or similar to those detailed above and include a low threshold velocity of one or more vehicles or other adverse traffic event.

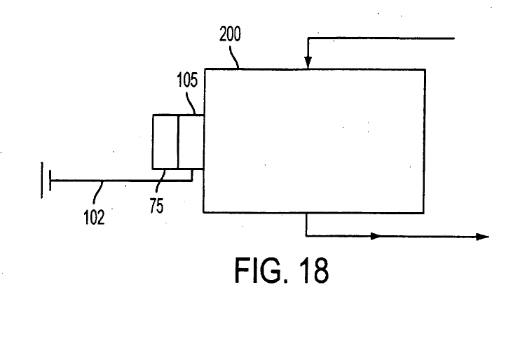

The transmitters T1 . . . T4 are located on vehicles V1 . . . V4, respectively, along with receiver systems R1 . . . R4. The receiver systems R1 . . . R4 include a non-negative acceleration control module and possibly an optional de-celeration or negative acceleration module. The components of the inter-vehicle congestion control system are shown in FIG. 18. The inter-vehicle embodiment of the invention has particular advantages and drawbacks when compared to the preferred embodiment.

Advantages of the inter-vehicle system include the fact that activation modules A may be placed a various locations as they are necessary to traffic control, and are therefore more “portable” than the preferred embodiments. Much longer stretches of roadway may be covered by the control system for less infrastructure cost. However, increasing the complexity of the electronics needed in the vehicle, transmitter, distance computation device, and receiving and acceleration control system would appear to decrease many of the economical advantages of the preferred embodiments which require only passive reception devices in vehicles coupled with acceleration or velocity controllers.

Another alternate implementation of the inter-vehicle system is where there are no external activation modules. However, the increasingly complex circuitry and transmission devices needed inside the automobile may prohibit many drivers from subscribing to such a system. However, the cost of serious traffic congestion results in lost revenue for governments and businesses as well as lost wages to individuals. As traffic infrastructure becomes increasingly volatile the cost of alternate embodiments may become an economically viable options even if devices for transmission and non-negative acceleration control must be provided to drivers.

FIG. 18 depicts the features of the inter-vehicle traffic control system.

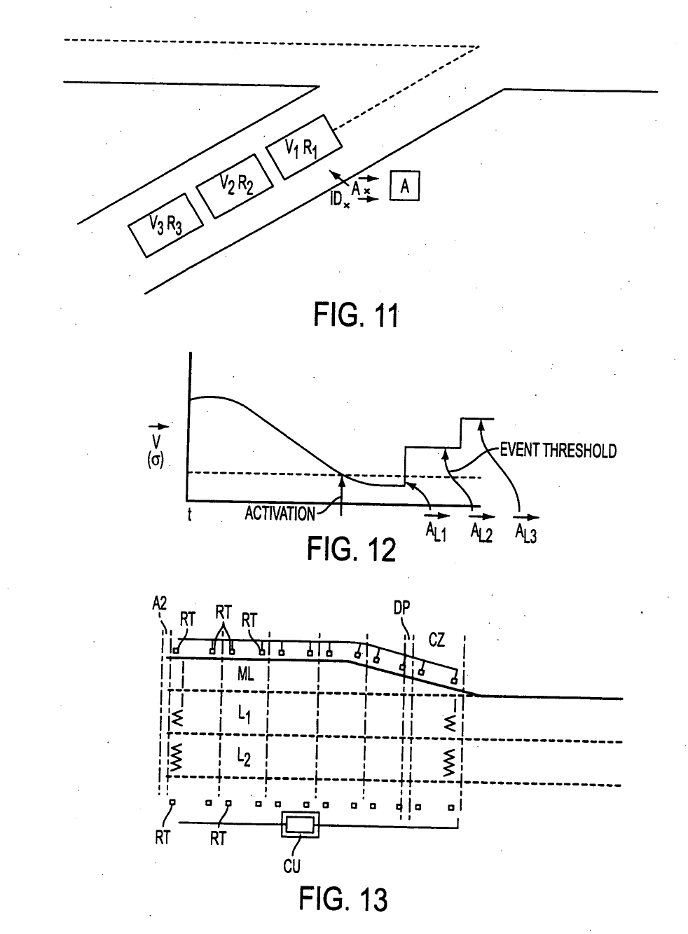

Referring now to FIG. 11, a simplified alternate embodiment for merge congestion is shown. Instead of an ineffective traffic light for an on-ramp that may or may not be effective at regulating merges during heavy traffic periods or even take into account that spacing in the travel lane TL may be such that regulating the merge lane ML is not needed. The simplified merge system has an activation or transmission device A at a targeted location at the end of the on-ramp. The activation device A may be connected to a timing or spacing detector TM which may be connected to detection devices at detection points DP1 or DP2, or simply include any required electronics for detecting appropriate criteria for merging. The activation module A may simply prevent vehicles from entering the merge into the travel lane TL by reducing or eliminating their ability to accelerate.

Referring now to FIG. 13 a multiple lane embodiment of the invention is shown for a highway merge. The transmitters are shown at points through the congestion control zone on multiple sides of the highway. The flow of information from transmitter to transmitter (or simultaneously) will depend on the roadway conditions. However, in the illustrative merge, the critical zones or important zones are most likely where the merge finally ends and drivers fail to space in the travel lane, creating gridlock. Thus, information on those zones would flow from the front of the congestion control zone to the back, either simultaneously, or in a staggered fashion, such that the vehicles multiple lanes can be spaces as to inhibit congestion.

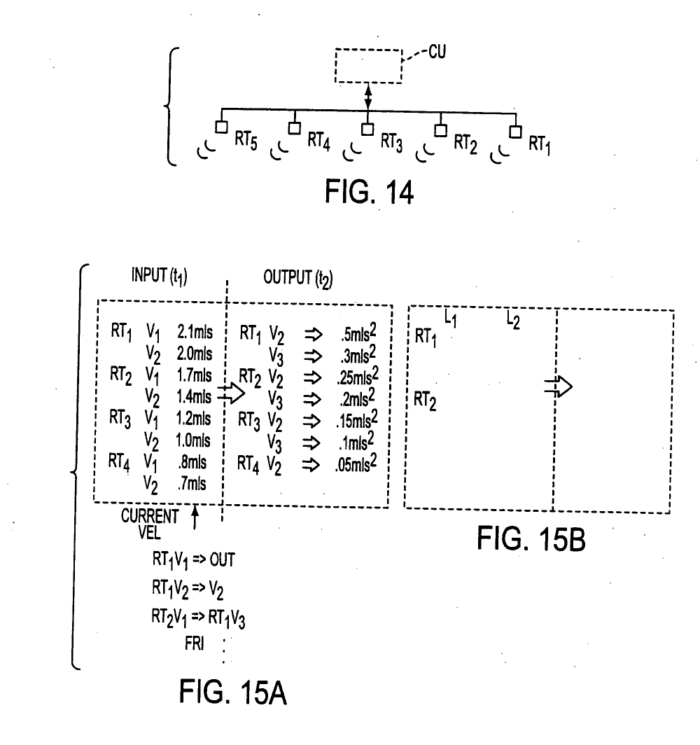

Referring now to FIG. 14 a networked series of transmission systems T1 . . . connected to each other via a LAN, WAN, or wireless network to a physical or virtual computation device CU. The computation device considers the information form the various transmitters T₁, . . . , in the optional embodiment or simply calculates targeted velocity or acceleration control to be transmitted to vehicles in particular zones. The computation device CU may record data or actually control the transmissions and may be located anywhere in the networked system. The control computations will depend on many parameters, lanes, regional traffic conditions, driver behavior, recorded traffic events. Some of these are discussed in the incorporated references. A simplified example of a representative single lane traffic flow computation table is shown at FIG. 15A and a multiple lane traffic flow computation at FIG. 15B. The tables are meant to be representative only of the information as can be appreciated by those skilled in the art.

Referring now to FIGS. 16A and 16B, an alternate physical-control embodiment of the invention is shown a two distinct points in time. The stopped vehicle or slow activates the spacing system at the activation zone which allows spacers to prevent vehicles from bunching up or “stop and go.” The Spacers can be physical devices such as Kevlar flags attached to a moving conveyor (with appropriate springs or other mechanical protection in the mechanical movement area or layer (FIG. 3) or can be electronic such as lights or diodes, but also can be transmitters which control the speed of the vehicle.

The control layer includes all necessary logic and electronic needed to move or control the sensors. There are many different methods for configuring each representation layers shown, including the mechanical layer in which the spacers move back to the activation zone. The length of the speed control area is vital in determining what physical configuration should be used.

A narrow strip down the center of the roadway containing the structures that control the spacers in addition to the spacers themselves may be sufficient for temporary use. However more permanent structures built into the roadway are contemplated.

The alternate physical control embodiment includes a physical control layer with all necessary logic and electronics needed to move or control the regulators or sensors. There are many different methods for configuring each representation layers shown, including the mechanical layer in which the spacers move back to the activation zone. The length of the speed control area is vital in determining what physical configuration should be used.

A narrow strip down the center of the roadway containing the structures that control the spacers in addition to the spacers themselves may be sufficient for temporary use. However more permanent structures built into the roadway are contemplated.

The invention herein is described in several embodiments that are not meant to be exhaustive but rather illustrative only. As can be appreciated by traffic and transportation specialists, there are other way to implement the invention which do not depart from the scope of the invention and thus, the invention should be considered as defined by the claims below.

1. A traffic control system for a traffic congestion zone, including: a traffic event sensing system;
a traffic spacing system activated when said traffic event sensing system detects a first criteria;
said traffic spacing system including a plurality of vehicle speed regulation devices;
wherein at least a first of said plurality of vehicle speed regulating devices has a lower vehicle speed limit than a second of said plurality of vehicle speed regulating devices, said first speed regulating device is behind said second speed regulating device in said traffic congestion zone, whereby at least two vehicles controlled by said first and second in said congestion zone are spaced apart as they move forward in said traffic congestion zone.

2. The traffic control system as recited in claim 1, wherein said first criteria is the speed of a vehicle located near the exit of said traffic congestion zone.

3. The traffic control system as recited in claim 2, wherein said speed of a vehicle is stopped.

4. The traffic control system as recited in claim 2, wherein said speed of a vehicle is measured over a period of time.

5. The traffic control system as recited in claim 2, wherein said event detector is located on said roadway.

6. The traffic control system as recited in claim 2, wherein said event detector is a RADAR.

7-10. (canceled)

11. The traffic control system as recited in claim 1, wherein at least one speed regulation device includes at least one transponder.

12. The traffic control system as recited in claim 1, wherein at least one speed regulation device includes at least one broadcast device located along a roadway.

13. The traffic control system as recited in claim 12, wherein at least one regulation device includes a receiver.

14-26. (canceled)

27. A method for reducing traffic congestion in a traffic congestion area including the steps of:
detecting an event causing a traffic congestion;
detecting an initial distance between at least a first two vehicles in a plurality, of control zones;
causing said initial distance to increase by limiting the acceleration of at least one vehicle in at least one of said plurality of zones;
detecting an intermediate distance between at least a second two vehicle in said plurality of control zones;
causing said intermediate distance to increase if said intermediate distance is not within a target; and
detecting an end to said traffic congestion if a target distance is detected between two vehicles in one of said plurality of control zones.

28. The method as recited in claim 27, wherein said initial distance is detected by speed strips.

29. The method as recited in claim 27, wherein said initial distance is detected by RADAR.

30. The method as recited in claim 27, further including the act of measuring said velocity of said first two vehicles nearly simultaneous to measuring said initial distance.

31. The method as recited in claim 30, including the act of measuring said velocity of said second two vehicles nearly simultaneous to measuring said intermediate distance.

32. The method recited in claim 27, wherein said limiting of acceleration is caused by mechanical means.

33. The method recited in claim 27, wherein said limiting of acceleration is caused by an RFID acceleration control system.

34. The method as recited in claim 27, wherein said limiting of acceleration is controlled by a device that includes broadcast devices located along a roadway.

35. The method as recited in claim 34, wherein said limiting of acceleration is received in the vehicle by an acceleration governor.

36. The method as recited in claim.35, wherein said acceleration governor includes a reception device.

37. The method as recited in claim 36, wherein said reception device accepts EM signals from said broadcast device located along said roadway.

38. The method as recited in claim 36, wherein said reception device includes an RFID that can be read by a transponder.

39-42. (canceled)

43. The method as recited in claim 27, wherein said causing said initial distance to increase step includes the act of receiving information from one or more units corresponding to a speed of at least one leading vehicle located ahead of said at least one vehicle.

44. The method as recited in claim 43, wherein said information is received by EMF transmission.

45. The method as recited in claim 43, wherein said information is received through a LAN network.

46. The method as recited in claim 43, wherein said causing initial distance step further includes calculating a target distance by processing said information from one or more units before transmitting said acceleration limit information, said acceleration limit always corresponding to a speed less than said speed information received from a forward unit.

47. The method as recited in claim 46, wherein said information is from a plurality of forward units.

48. The method as recited in claim 47, where said information is weighted such that the speed information from the forward most unit receives the east weight in determining said acceleration limit.

49. The method as recited in claim 27, wherein said acceleration limiting may only limit positive acceleration.

50. The method as recited in claim 49, wherein said acceleration limiting step may only occur if a speed of one of said vehicles has reached a low threshold.

51-78. (canceled)

79. A method for reducing traffic congestion including the acts of:
placing an acceleration limiting reception device in each of a plurality of vehicles;
activating at least one of said plurality acceleration limiting reception devices in a congestion reduction zone; and
transmitting instructions to at least one of said plurality of acceleration limiting reception devices in at least one vehicle located in said congestion reduction zone, wherein said transmitted instruction cause the non-negative acceleration of a vehicle to be limited.

80. The traffic congestion reduction method as recited in claim 79, wherein said activation takes place when a traffic event is detected.

81. The traffic congestion reduction method as recited in claim 79, further including the step of deactivating said at least one of said plurality of acceleration limiting device.

82-83. (canceled)
